(19) United States
(12) Patent Application Publication
(10) Pub. No.: US 2022/0234418 A1
(43) Pub. Date: Jul. 28, 2022

(54) AIR CONDITIONING RECIRCULATION MODE FOR VEHICLE

(71) Applicant: Honda Motor Co., Ltd., Tokyo (JP)

(72) Inventors: Danny JIERIAN, Dublin, OH (US); Nigel Wynne WILLIAMS, Raymond, OH (US); Kyle E. CHRISTMAN, Columbus, OH (US); Daniel R. YELLES, Marysville, OH (US); Derek S. ADELMAN, Hilliard, OH (US); Jason C. D. CHUANG, Hilliard, OH (US); Trevor F. BURNS, Milford Center, OH (US); Hiroshi NAKAGAWA, Dublin, OH (US); Veronick MARTINUZZI, Raymond, OH (US); Brock J. STULL, Columbus, OH (US)

(21) Appl. No.: 17/161,283

(22) Filed: Jan. 28, 2021

(51) Int. Cl. B60H 1/00

(52) U.S. Cl. CPC B60H 1/00849

(57) ABSTRACT

An HVAC system for a vehicle includes a control unit for controlling the HVAC system and an air recirculation unit controlled by the control unit that is operable in an automatic mode and a manual mode. In the automatic mode, the air control unit is operable to determine if a sunroof is applied to the vehicle, determine if the control unit can determine whether the sunroof is open or closed, determine if the sunroof is open or closed, and change an operating condition of the air recirculation unit in the automatic mode from a first operating level to a second operating level if the sunroof is determined to be open.

### TECHNICAL FIELD

The embodiments disclosed herein are related to control of air flow in a vehicle with a sunroof.

### BACKGROUND

Vehicles are commonly equipped with air conditioning systems so as to provide comfort to the vehicle's driver and passengers on hot summer days. An air conditioning system includes an air compressor which is powered by the vehicle's motor, for driving a highly-volatile refrigerant through a system that includes a condenser, an expansion valve and an evaporator, as is well known. In a typical vehicle air conditioning system, fresh outside air is brought into the system and cooled down, after which it is blown into the vehicle cabin.

Several conditions influence the performance and efficiency of an air conditioning system, such as ambient temperature and humidity. Under hot, humid ambient conditions, the air conditioning system performs work to cool down and remove moisture from the fresh air to obtain a desired temperature and humidity within the vehicle. This fresh air is continually being added to the already-cooled air in the vehicle cabin. Since air is continually flowing in, the air conditioning system creates a positive pressure within the vehicle cabin, and so the already-cooled and dried air is continually seeping out of the vehicle cabin, resulting in air cooling losses. Thus, the air conditioning must perform constant work just to maintain a desired level of temperature and humidity within the vehicle cabin.

However, a vehicle air conditioning system is powered by the vehicle engine, and so the increased operation of the air conditioning system contributes to the engine load, which results in the consumption of additional fuel, thereby reducing fuel efficiency. It has therefore been previously contemplated to recirculate the already-cooled air in the vehicle cabin into the air conditioning system. This approach maintains the temperature and humidity level of already-cooled air, and reduces the cabin air cooling losses, and thereby reduces the load of fresh air coming into the system. In a “recirculation” mode, dampers may be closed to prevent introduction of fresh air into the vehicle, and rather draws air from the passenger compartment.

However, applying vehicle recirculation to aid in cooling with a sunroof tilted open, as is often the case when a vehicle passenger compartment is extremely hot, may lead to a loud wind noise level specifically in the passenger cabin from 0-10 kHz, mainly above 500 Hz.

With standards and regulations governing clean air and fuel conservation, it is highly desirable to reduce fuel consumption wherever possible, particularly if this goal can be attained without a reduction in performance or end-user expectations. It would be highly desirable to control the amount of recirculated air, and/or provide a mixture of recirculated and fresh air, for the purpose of reducing noise in the passenger cabin.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a method of operating an HVAC system of a vehicle, the HVAC system having a control unit for controlling the HVAC system and an air recirculation unit operable in an automatic mode or a manual mode, includes determining if a sunroof is applied to the vehicle, determining if the control unit can determine whether the sunroof is open or closed, determining if the sunroof is open or closed, and changing an operating condition of the air recirculation unit in the automatic mode from a first operating level to a second operating level if the sunroof is determined to be open.

According to another aspect, a method of operating a vehicle including an HVAC system having a control unit and an air recirculation unit operable in an automatic mode includes determining if a sunroof is applied to the vehicle, determining if the control unit can determine whether the sunroof is open or closed, determining if the sunroof is open or closed, and changing an operating condition of the air recirculation unit in the automatic mode from a first operating level to a second operating level if the sunroof is determined to be open.

According to yet another aspect, an HVAC system for a vehicle includes a control unit for controlling the HVAC system, and an air recirculation unit controlled by the control unit and operable in an automatic mode and a manual mode, wherein in the automatic mode, the air control unit is operable to determine if a sunroof is applied to the vehicle, determine if the control unit can determine whether the sunroof is open or closed, determine if the sunroof is open or closed, and change an operating condition of the air recirculation unit in the automatic mode from a first operating level to a second operating level if the sunroof is determined to be open.

### BRIEF DESCRIPTION OF THE DRAWINGS

FIG. 1 is top perspective view of a portion of vehicle with an open sunroof.

FIG. 2 is a side perspective view of a portion of a vehicle with a tilted open panoramic sunroof.

FIG. 3 is a schematic view of an HVAC system and power window system of a vehicle.

FIG. 4 is a flowchart of a method of controlling an air recirculation unit of the HVAC system of the vehicle.

FIG. 5 is a graph illustrating the results of an Example A of operation of the method of FIG. 4.

FIG. 6 is a graph illustrating the results of an Example B of operation of the method of FIG. 4.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

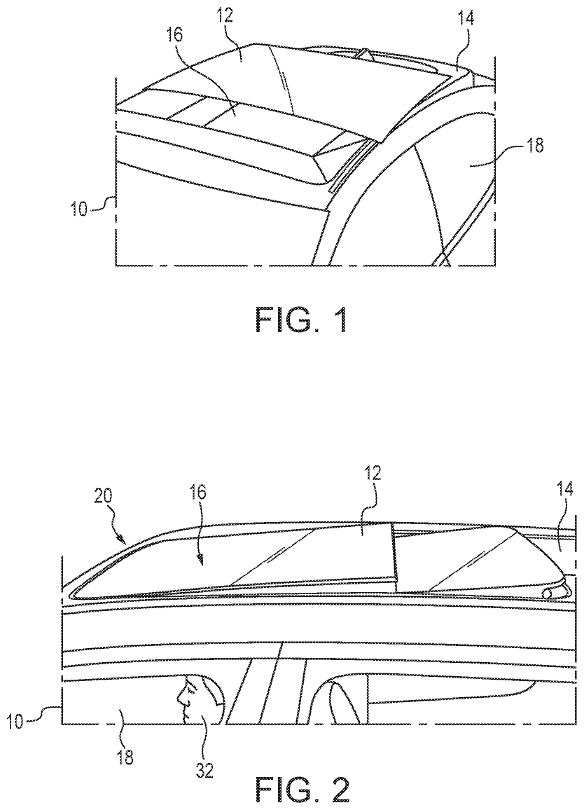

FIG. 1 is a top view of a vehicle 10 that includes a sunroof 12 in a roof 14 of the vehicle 10. A sunroof 12 is a movable panel that is operable to uncover a window opening 16 in the roof 14, which allows light and/or fresh air to enter a passenger compartment 18 of the vehicle 10. The sunroof 12 may be either manually operated or motor driven, and the sunroof 12 may be available in many shapes, sizes, and styles. A sunroof 12 of the spoiler type, also described as a tilt-and-slides, and illustrated in FIG. 1, combines the features of a pop-up-type sunroof with those of a sliding roof system. The sunroof 12 may tilt to vent, as illustrated in FIG. 2, and slide open above the roof 14, as illustrated in FIG. 1, requiring little headroom or roof length. A sunroof 12 of the spoiler type typically do not provide as large an window opening 16 as other roof systems, but offer the convenience of a self-storing panel. Most sunroofs 12 of the spoiler-type are electric, with optional features like integrated sun shades and express open/close. A sunroof 12 of the inbuilt-type has a panel which slides between the metal roof 14 and interior headliner (not-shown) in the passenger compartment 18, requiring some loss of headroom but providing a full window opening 16 in the roof 14. Any sunroof 12 that is inbuilt slides inside the roof 14, while some also include a rear venting feature (see pop-up), and/or express open/close functions. An Inbuilt sunroof 12 may not fit every vehicle 10, as the panel must slide and store completely within the vehicle roof. Historically, a sunroof 12 inbuilt was a metal sunroof panel painted to match the vehicle roof 14, but now most are glass-panel systems with sliding sunshades

Panoramic roof systems 20, as illustrated in FIG. 2 are a type of large or multi-panel sunroof 12 which offer openings above both the front and rear seats and may be operable or fixed glass panels. Large operable window openings 16 are often accomplished with inbuilt, top-slider (tracks in the top of the roof 14), or spoiler-type mechanisms.

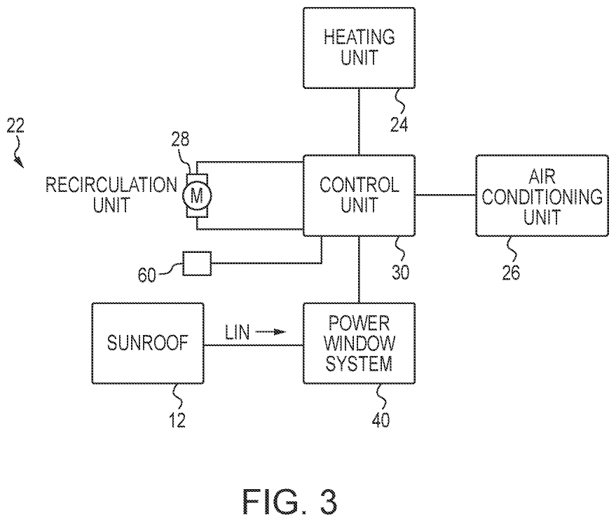

The vehicle may also be equipped with a heating, ventilation, and air-conditioning (“HVAC”) system 22, schematically illustrated in FIG. 3. The HVAC system 22 includes a heating unit 24 for heating air, an air conditioning unit 26 for cooling and dehumidifying air, and a recirculation unit 28 for controlling the mix of fresh air and recirculated from the passenger compartment 18 moving through the HVAC system 22. Using the recirculation unit 28 helps to cool the vehicle 10 as quickly as possible when it is warm outside of the vehicle 10 and the air conditioning unit 26 of the HVAC system 22 is on. The recirculation unit 28 recirculates the cool air produced by the air conditioning unit 26 and delivered to the passenger compartment 18 and reduces the flow of fresh air from outside of the vehicle 10. If fresh air from outside the vehicle 10 that is much warmer in the summer is used, the air conditioning unit 26 must work continuously to cool the hot air from the outside when pulling it into the vehicle 10, creating undue wear-and-tear on the air conditioning unit 26 and reducing fuel economy as a result.

Additionally, the recirculation unit 28 may be effective to reduce the flow of polluted air from another vehicle into the passenger compartment 18, such as when following another vehicle with combustion or muffler problems.

The HVAC system 22 may also be equipped with a control unit 30 that includes an automatic setting that allows the user 32, such as the driver, to select a temperature for the vehicle 10 while the control unit 30 controls the HVAC system 22 to operate in an automatic mode. Alternatively, the user 32 of the vehicle 10 may make manual selections as to temperature control, fan speed, and recirculation.

Finally, the recirculation unit 28 may be used to determine the source of vented air moving through the vehicle 10 when the HVAC system 22 is off, or additionally when the selected temperature does not require operation of either the heating unit 24 or the air conditioning unit 26.

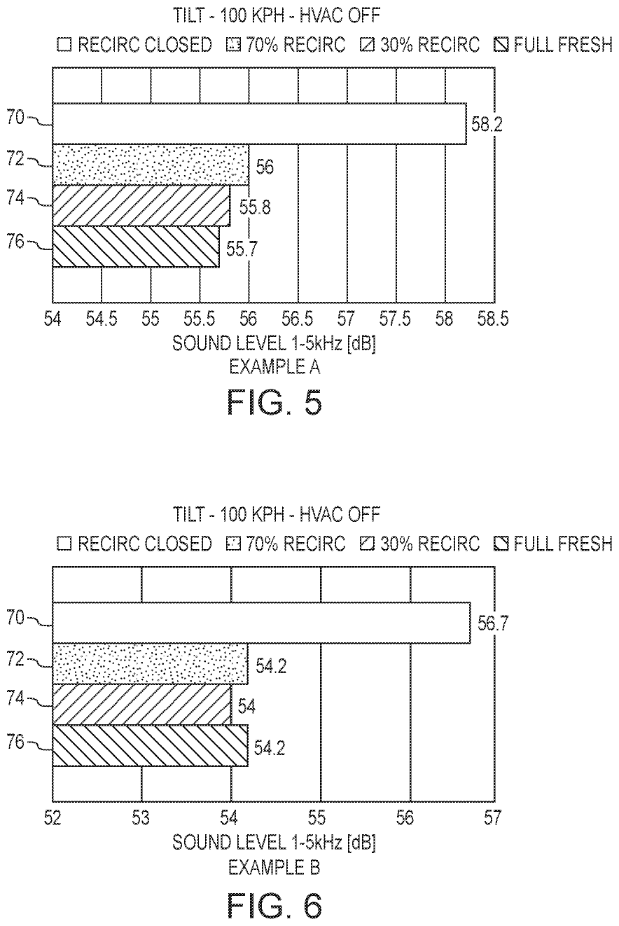

Based on increased wind noise, logic was created to limit recirculation operation when the sunroof 12 is open, as illustrated in either FIG. 1 or 2, and the vehicle 10 is in an automatic mode for operation of the HVAC system 22. The HVAC system 22 may not be using the air conditioning unit 26 or heating unit 24, or, more likely, the HVAC system 22 is turned off in order to choose the source of vented air, either from outside of the vehicle 10 or recirculated air from the passenger compartment 18. This is particularly necessary, but not limited to, when the sunroof 12 applied to the vehicle is of the panoramic-type, and the user 32 selects a panorama tilt mode, as illustrated in FIG. 2. The logic may improve the overall decibel (“dB”) level when the user 32 chooses the panorama tilt mode. This logic only applies when auto recirculation is chosen, and will limit recirculation operation to a specified value, which in the examples disclosed below and in FIGS. 5-6, may be set to approximately 70%. The user 32 may still chose manual 100% recirculation regardless of sunroof 12 position.

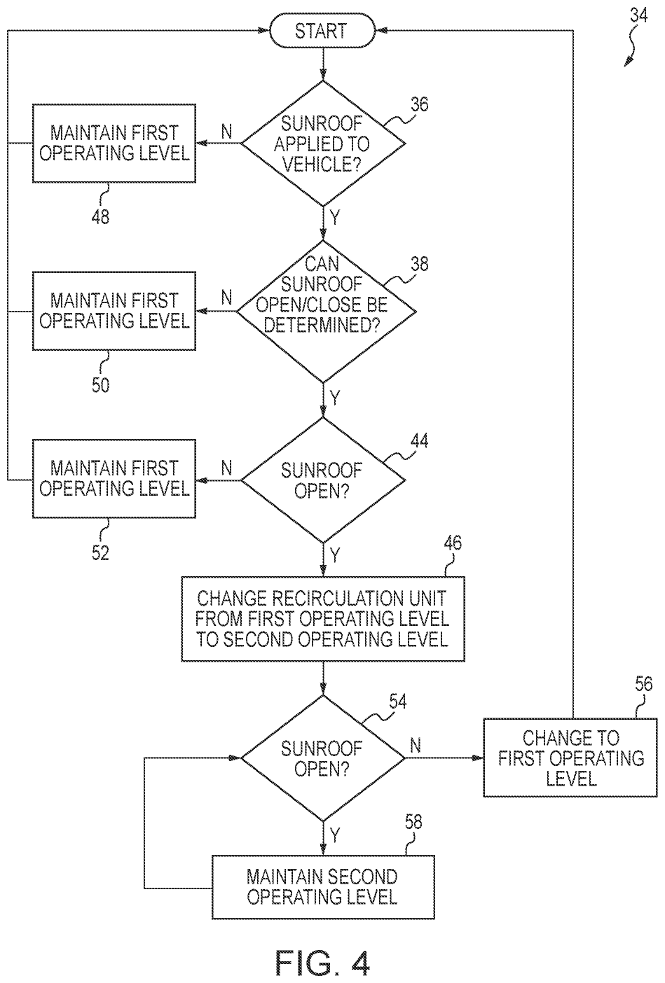

The method 34 of operation of the control unit 30 while controlling the air HVAC system 22 in a vehicle 10 and controlling the air recirculation unit 28 in an automatic mode, as illustrated in FIG. 4, is as follows. First, the control unit 30 determines whether a sunroof 12 is applied to the vehicle 10 in step 36. The step 36 is necessary as not all trim levels of a vehicle 10 may have an applied sunroof 12, but the control unit 30 of the HVAC system 22 may be common across all trim levels.

Next, in step 38 the control unit 30 determines if the HVAC system 22 can determine whether the sunroof 12 is open or closed. It may be possible that the connection between control unit 30 and the either the power window system 40 or the sunroof 12 are not connected. This lack of connection may be present from the factory, which thus yields the same result every time. Alternatively, the lack of a connection may be transient or the result of disconnected or broken bus 42 or some other part failure.

If the control unit 30 can determine if the sunroof 12 is open or closed, the next step 44 is to actually make the determination whether the sunroof 12 is open or closed. The final step 46 of the base method 34 is to change an operating condition of the air recirculation unit 28 in the automatic mode from a first operating level 70 to a second operating level 72 if the sunroof 12 is determined to be open. The first operating level 70 of the recirculation unit 28 shown in Example A, FIG. 5, and shown in Example B, FIG. 6, is for the recirculation unit 28 in a fully closed state, i.e. full recirculation of air from the passenger compartment 18 and outside fresh air completely blocked.

FIG. 5 illustrates the effect of the method 34 for Example A, in which the second operating level 72 is approximately 70%, in which the recirculation unit 28 is 70% closed and 30% open to fresh air from outside of the vehicle 10. In Example A, a reduction in passenger compartment 18 noise level, with passenger compartment 18 noise measured at a frequency of 5 kHz, the sunroof 12 in a tilt condition, and the vehicle 10 moving at 100 kph, was measured from 58.2 dB to 56 dB when moving from the first operating level 70 to the second operating level 72. As further shown, moving to a third operating level 74 of 30%, in which the recirculation unit 28 is 30% closed and 70% open to fresh air from outside the vehicle 10 only provided a further reduction in passenger compartment 18 noise to 55.8 dB. In a fourth operating level 76, with a fully open recirculation unit 28 with 100% fresh air, the passenger compartment 18 noise level only dropped to 55.7 dB. Thus, the greatest impact was movement from the first operating level 70 to the second operating level 72.

FIG. 6 illustrates the effect of the method for Example B, in which the second operating level 72 is approximately 70%, in which the recirculation unit 28 is 70% closed and 30% open to fresh air from outside of the vehicle 10. In Example B, a reduction in passenger compartment 18 noise level, with passenger compartment 18 noise measured at a frequency of 5 kHz, the sunroof 12 in a tilt condition, and the vehicle 10 moving at 100 kph, was measured from 56.7 dB to 54.2 dB when moving from the first operating level 70 to the second operating level 72. As further shown, moving to a third operating level 74 of 30%, in which the recirculation unit 28 is 30% closed and 70% open to fresh air from outside the vehicle 10 only provided a further reduction in passenger compartment 18 noise to 54 dB. In a fourth operating level 76, with a fully open recirculation unit 28 with 100% fresh air, the passenger compartment 18 noise level rose back to 54.2 dB. Thus, the greatest impact in Example B, as with Example A, was movement from the first operating level 70 to the second operating level 72.

While the examples above indicate improvement in the 1-5 kHz range, improvements may be found in bands ranging from 0-10 kHz.

Additional steps may further be applied to the method 34 of operation of the control unit 30 illustrated in FIG. 4. The next step may be include maintaining the operating condition of the air recirculation unit 28 at the first operating level 70 if the sunroof 12 is not applied to the vehicle 10. If the sunroof 12 is not applied, there is no need to adjust the recirculation unit 28.

Next, the method 34 of operation of the control unit 30 includes maintaining the operating condition of the air recirculation unit 28 at the first operating level 70 if the control unit 30 cannot determine whether the sunroof 12 is open or closed. Thus, the failsafe operation is to maintain the first operating level 70 in the event the control unit 30 cannot determine if the sunroof 12 is open.

Additionally, the method 34 of operation of the control unit 30 may include the step 52 maintaining the operating condition of the air recirculation unit 28 at the first operating level 70 if the sunroof 12 is determined to be closed.

The control unit 30 may continue to check if the sunroof 12 is open or closed in step 54. If the control unit 30 determines that the sunroof 12 has moved from closed to open, the control unit 30 may move the air recirculation unit 28 from the first operating level 70 to the second operating level 72 through repeating the method 34. If the control unit 30 determines that the sunroof 12 has moved from open to closed, the control unit 30 returns the air recirculation unit 28 to the first operating level 70 from the second operating level 72 in step 56. If the control unit 30 determines that the sunroof 12 remains open, the control unit maintains the air recirculation unit in the second operating level 72 in step 58.

Finally, the method 34 of operation of the control unit 30 may be overridden by user 32 of the vehicle 10 overriding the automatic mode of the HVAC system 22 by manually selecting air recirculation by pressing button 60, in which case the air recirculation unit 28 is returned to the first operating level 70 from the second operating level 72.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A method of operating an HVAC system of a vehicle, the HVAC system having a control unit for controlling the HVAC system and an air recirculation unit operable in an automatic mode or a manual mode, comprising the steps of:
determining if a sunroof is applied to the vehicle;
determining if the control unit can determine whether the sunroof is open or closed;
determining if the sunroof is open or closed; and
changing an operating condition of the air recirculation unit in the automatic mode from a first operating level to a second operating level if the sunroof is determined to be open.

2. The method of claim 1 further comprising the step of:
maintaining the operating condition of the air recirculation unit at the first operating level if the sunroof is not applied to the vehicle.

3. The method of claim 2 further comprising the step of:
maintaining the operating condition of the air recirculation unit at the first operating level if the control unit cannot determine whether the sunroof is open or closed.

4. The method of claim 3 further comprising the step of:
maintaining the operating condition of the air recirculation unit at the first operating level if the sunroof is determined to be closed.

5. The method of claim 4 further comprising the step of:
determining that the sunroof has moved from closed to open; and
moving the operating condition of the air recirculation unit from the first operating level to the second operating level.

6. The method of claim 1 further comprising the step of:
overriding the automatic mode of the air recirculation unit by a user of the vehicle; and
returning the operating condition of the air recirculation unit to the first operating level from the second operating level.

7. The method of claim 1 further comprising the step of:
determining if the sunroof has moved from open to closed; and
returning operating condition of the air recirculation unit to the first operating level from the second operating level.

8. A method of operating a vehicle including an HVAC system having a control unit and an air recirculation unit operable in an automatic mode, comprising the steps of:
determining if a sunroof is applied to the vehicle;
determining if the control unit can determine whether the sunroof is open or closed;
determining if the sunroof is open or closed; and
changing an operating condition of the air recirculation unit in the automatic mode from a first operating level to a second operating level if the sunroof is determined to be open.

9. The method of claim 8 further comprising the step of:
maintaining the operating condition of the air recirculation unit at the first operating level if the sunroof is not applied to the vehicle.

10. The method of claim 9 further comprising the step of:
maintaining the operating condition of the air recirculation unit at the first operating level if the control unit cannot determine whether the sunroof is open or closed.

11. The method of claim 10 further comprising the step of:
maintaining the operating condition of the air recirculation unit at the first operating level if the sunroof is determined to be closed.

12. The method of claim 11 further comprising the step of:
determining that the sunroof has moved from closed to open; and
moving the operating condition of the air recirculation unit from the first operating level to the second operating level.

13. The method of claim 8 further comprising the step of:
overriding the automatic mode of the air recirculation unit by a user of the vehicle; and
returning the operating condition of the air recirculation feature to the first operating level from the second operating level.

14. The method of claim 8 further comprising the step of:
determining if the sunroof has moved from open to closed; and
returning the operating condition of the air recirculation unit to the first operating level from the second operating level.

15. An HVAC system for a vehicle, comprising:
a control unit for controlling the HVAC system;
an air recirculation unit controlled by the control unit and operable in an automatic mode and a manual mode; and
wherein in the automatic mode, the air control unit is operable to:
determine if a sunroof is applied to the vehicle;
determine if the control unit can determine whether the sunroof is open or closed;
determine if the sunroof is open or closed; and
change an operating condition of the air recirculation unit in the automatic mode from a first operating level to a second operating level if the sunroof is determined to be open.

16. The system of claim 15 wherein the control unit maintains the operating condition of the air recirculation unit at the first operating level if the sunroof is not applied to the vehicle or if the control unit cannot determine whether the sunroof is open or closed.

17. The system of claim 15 wherein the control unit maintains the operating condition of the air recirculation unit at the first operating level if the sunroof is determined to be closed.

18. The system of claim 17 wherein if the control unit determines that the sunroof has moved from closed to open, the system moves the operating condition of the air recirculation unit from the first operating level to the second operating level.

19. The system of claim 15 wherein the control unit:
overrides the automatic mode of the air recirculation unit by a user of the vehicle; and
returns the operating condition of the air recirculation unit to the first operating level from the second operating level.

20. The system of claim 15 wherein the control unit:
determines if the sunroof has moved from open to closed; and
returns the operating condition of the air recirculation unit to the first operating level from the second operating level.
